(19) United States
(12) Patent Application Publication
(10) Pub. No.: US 2022/0125138 A1
(43) Pub. Date: Apr. 28, 2022

(54) CLOTHING FOR YOUNG PEOPLE WITH FUNCTIONAL DIVERSITY

(71) Applicant: BESSIE ANN MARTINEZ, Bayamon, PR (US)

(72) Inventor: BESSIE ANN MARTINEZ, Bayamon, PR (US)

(21) Appl. No.: 17/507,860

(22) Filed: Oct. 22, 2021

Related U.S. Application Data
(60) Provisional application No. 63/104,542, filed on Oct. 23, 2020.

(51) Int. Cl. A41D 15/00; A41D 11/00; G09B 19/00

(52) U.S. Cl. CPC A41D 15/005; A47G 25/90; G09B 19/0076; A41D 11/00

(57) ABSTRACT

The invention relates a reversible clothing item that is formed from two layers of fabric bonded to each other and are configured to facilitate disable individuals to dress themselves.

### CROSS-REFERENCE TO RELATED APPLICATION

This application claims priority from U.S. Provisional Patent application 63/104,542 filed on Oct. 23, 2020, which is hereby incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1. Field of the Invention

The invention relates to clothing specifically designed to assist people with disabilities to get dressed, and, more particularly to clothing designed to assist individuals put their clothes and shoes on without the assistance of another r individual.

### 2. Description of Related Art

The prior art is replete with clothing that is either weighted or has closures that prevent an individual from removing the article of clothing. However, none of these previous inventions facilitate a disabled individual to dress themselves.

Therefore, what is needed in the art is clothing that facilitates an individual with disabilities to put their clothing on without assistance from another person.

### BRIEF SUMMARY OF THE INVENTION

The invention in one form is directed to a clothing article that provides a positive means for a person with disabilities to put their clothing on and prevent the possibility of putting it on backwards. .

The invention in one form allows a person with disabilities to put their shoes properly without assistance.

The invention in another form provides a means for a person with disabilities to put their shoes on without assistance from another individual.

In yet another form, the invention provides for casual, loose, comfortable and reversible clothing that has two sides and can be inverted by the wearer so that the logos are always presented right side out and that cloths do not have zippers, buttons or ties which make the clothing completely reversible.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows the first side of a shirt which can be worn in a reversible fashion and still looks casual, loose and comfortable and is formed from a first layer and second layer;

FIG. 2 shows the second side of a shirt which can be worn in a reversible fashion and still looks casual, loose and comfortable and is formed from a first layer and second layer;

FIG. 3 shows a method of bonding which incorporates a third layer which is placed between the first fabric layer and the second fabric layer;

FIG. 4 shows a typical logo;

FIG. 5 shows labels which provide an educational strategy for use by individuals with disabilities;

FIG. 6 shows an identification method of the instant invention for shoes comprising of an accessory type sticker that adheres inside the shoe.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

In the following description, numerous specific details are set forth. However, it is understood that embodiments of the invention may be practiced without these specific details. In other instances, well-known structures and techniques have not been shown in detail in order not to obscure the understanding of this description. Those of ordinary skill in the art, with the included descriptions, will be able to implement appropriate functionality without undue experimentation.

References in the specification to “one embodiment” or “an embodiment,” may indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that such feature, structure, or characteristic may be deployed in connection with other embodiments whether or not explicitly described.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms people, child, adult, user, consumer and individual are used interchangeably to mean an individual who uses the invention.

The term article of clothing as used within this specification is intended to mean any article that is used to dress an individual and includes but not limited to shirts, pants, socks, undergarments, foot ware, shoes, boots, sandals or socks, gloves, masks and hats.

The term items, garments, clothing, clothing item, apparel are used interchangeably to mean an article of clothing.

The term cloth and fabric are used interchangeably to mean an piece of fabric used to make the clothing or items of the instant invention.

The term shoes as used within this specification is intended to mean any foot wear such as shoes, boots, sandals or socks which have a right and left handed features.

The term gloves as used within this specification is intended to mean any hand covering which have a right and left handed features.

The term sewed as used within this specification is intended to mean fastening two or more pieces of cloth together and it the process of attaching the cloth can be selected from the group consisting of ultrasonic bonding, adhesive gluing, flat felled seam and a double lapped seam.

The prior art does not provide for a system that provides a system for supporting easy to use and promote the ability for people with disabilities to easily dress themselves without assistance from other individuals. Typical inventions include U.S. Pat. No. 10,542,783 issued to Winner, Jan. 28, 2020, U.S. Pat. No. 9,795,821 issued to Feldman Oct. 24, 2017, U.S. Pat. No. 8,701,214 issued to Stoneham, Apr. 22, 2014, U.S. Pat. No. 10,589,058 issued to Smith Mar. 17, 2020, U.S. Pat. No. 10,322,309 issued to Feldman Jun. 18, 2019, U.S. Patent application 20160082302, inventor Fieldman, published Mar. 24, 2016 the contents of which are incorporated by reference in their entirety. However, none provide for an easy to use clothing item which is design to promote self-dressing by disabled individuals.

Disabilities can make getting dressed independently difficult for a child or an adult. These skills can take longer to develop than for other children their age. In fact, the individual might always need some assistance. However, by designing clothing for people with functional diversity the clothes can provide the individual with a sense of independence and accomplishment. The clothing can provide inclusive fashion in its origin, aimed at children, adolescents and young and older people with functional diversity but that can actually be used by anyone. When the clothing provides positive reinforcement of accomplishment it facilitates and promote self-sufficiency.

People with functional diversity often have difficulty dressing, they put their clothes and shoes on backwards, they get frustrated because they cannot button or tie and there must always be someone to help them dress. The instant invention utilizes casual, loose, comfortable and reversible clothing line that have two sides and that permits the individual the ability to dress themselves. The reversable nature of the clothing allows it to always look good. By designing the clothing such that they do not have a zipper, buttons, or ties, it is easy to wear clothing. Also, by using high quality materials, and taking into account the needs of the individual and their sensory problems and the elimination of uncomfortable seams so that the seams are flat and not exposed it eliminates the points of irritation which many individuals with autism have and makes the dressing process more enjoyable for them. This is also addressed by elimination of zipper, buttons and ties. By using soft fabrics, made of cool and dry cotton and other fabrics and eliminating stitched branding by replacing it with stamped or printed brands that are reversable also addresses the feel issues which are a cause of distress for individuals with autism and other disabilities.

The instant invention also provides a safety element in the design. The instant invention uses labels and pictograms to provide means of training and education for people with disabilities so they can easily learn how to dress themselves. Once the product is purchased, the customer has the option of not discarding the label and instead use it to reinforce wearing skills and plan their outfits. This provides a built-in educational strategy that can be used with populations with disabilities to create structure. In addition, as the clothes are reversible and have 2 or more color patterns, you can make two, three, up to four variations with any outfit of two or more pieces. The clothing of the instant invention promotes self-reliance, helps with self-esteem, prevents bullying and helps families with children with disabilities.

The instant invention can be expanded to shoes and gloves with right and left side symmetry. A sticker-like accessory that is attached to the inside of the footprint to visually identify the left shoe in blue and the right shoe in red can be made from resilient reflective or colored material such as 3M Controltac Graphic Marking System or any suitable material and laminated to the shoe so as to identify the left and right shoe. The corresponding pants can also have a color code attached to the legs to help the individual match the right foot and left foot footwear to the correct foot. It can be used in open or closed footwear. The sticker is accompanied by a pictogram to reinforce use skills. The same sticker-like accessory can be used with gloves to identify left and right gloves to make the dressing process easier for the individual and for the person teaching the individual to dress.

The instant invention is worn by an individual such that the article of clothing has a side that is proximal to the individual and a distal side that is exposed and facing away from the body of the individual.

The instant invention is a reversible clothing article which is selectable reversible and comprises of a first fabric layer bonded to a second fabric layer such that the first fabric layer has a first visible logo and the second fabric layer having a second visible logo and the first visible logo is not visible when the second fabric layer is exposed away from the body of the individual and the second visible logo is not visible when the first fabric layer is exposed away from the body of the individual.

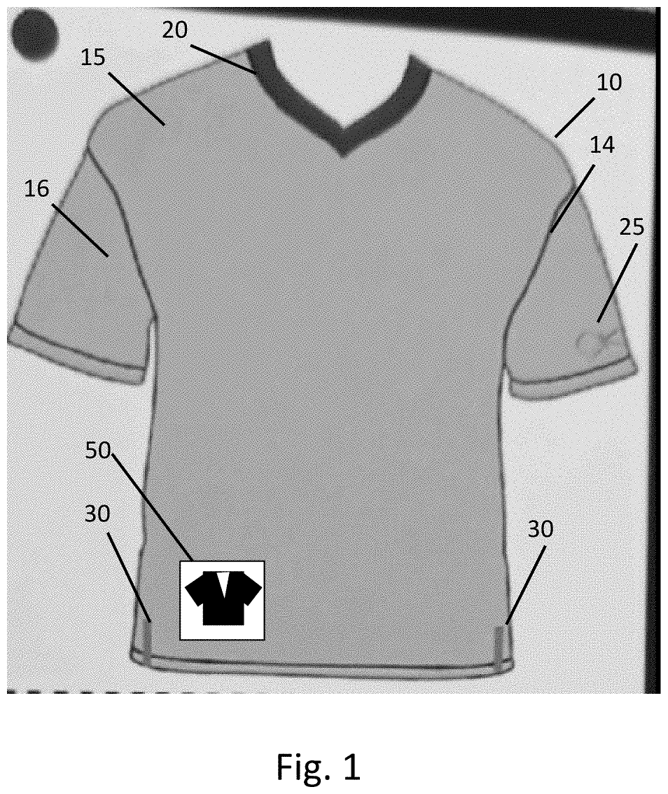

Referring now to the drawings FIG. 1-6 and more particularly to FIG. 1, there is shown a shirt which can be worn in a reversible fashion and still looks casual, loose and comfortable. The clothing is casual, loose, comfortable and reversible and has multiple different combinations which can be used by the individual. However regardless of how you wear it, it will always look good. The clothes do not have a zipper, buttons, or ties which makes it easy for a person with a disability to wear and provides a comfortable fit for the individual. By eliminating the zippers, buttons, or ties the instant invention simplifies the dressing process for a person with disabilities and facilitates the process of self-dressing which is a goal for all individuals and especially those individuals with a disability.

The clothes of the instant invention have collars and waist bands that are elastic and promote the ability of a disabled person to dress themselves without the need for another person assisting them. The waist bands have shirt vent that are bonded so that they provide comfort at the waist line and do not allow the color of the second side to be shown.

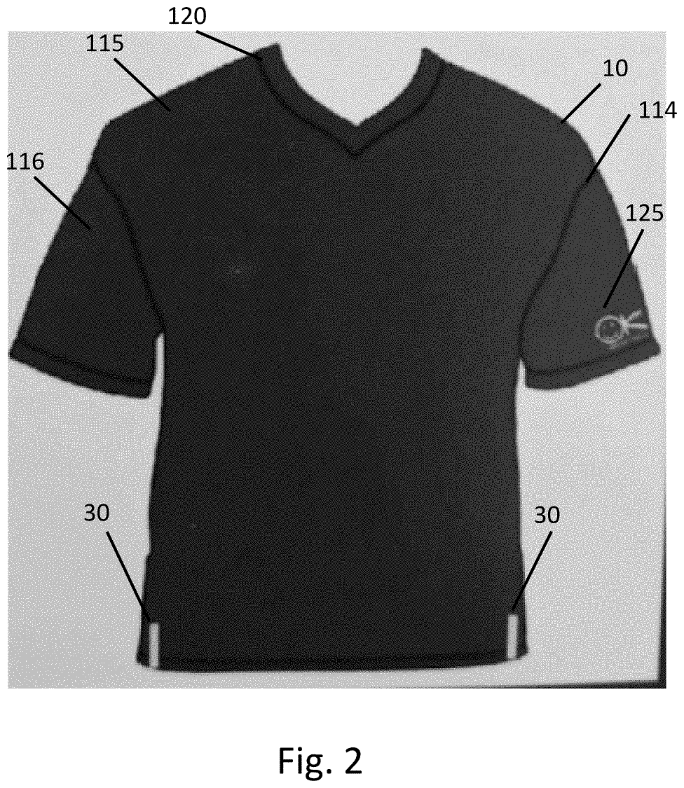

Referring to FIG. 1-FIG. 6 and specifically FIG. 1 and FIG. 2 the shirt 10 is selectable reversible and comprises of a first fabric layer 15 which is made of a plurality of pieces of fabric 16 to form the garment (as shown in FIG. 1 only piece one of fabric is identified for clarity). The first fabric layer 15 is sewn together such that the seams 14 are flat (as shown in FIG. 1 only one seam is identified for clarity). The process used to sew pieces of fabric together and form a flat seam can either be ultrasonic bonding, adhesive gluing, flat felled seam and a double lapped seam. The first fabric layer 15 is then bonded to a second fabric layer 115 shown in FIG. 2 which is made of a plurality of pieces of fabric 116 to form the garment (as shown in FIG. 2 only one piece of fabric is identified for clarity). The second fabric layer 115 is sewn together such that the seams 114 are flat (as shown in FIG. 2 only one seam is identified for clarity). The process used to sew pieces of fabric together to form a flat seam can either be ultrasonic bonding, adhesive gluing, flat felled seam and a double lapped seam. The first fabric layer collar 20 is made from the first fabric layer fabric 16 and it is folded so as to form the second fabric layer collar 120. However, the instant invention envisions the ability to form the collar from the fabric 16 of the first fabric layer 15 and the fabric 116 of the second fabric layer 115 and then bond them together. The shirt 10 can also have a label 50 identifying the piece of clothing and is used to help the individual dress themselves by matching the labels. The label 50 provides the user or individual when used with a pictogram describing the steps for dressing with a process or plan to dress themselves by matching labels with labels on the pictogram. The labels and pictogram can be used in the education of the individual as to the steps to take to dress themselves.

The first fabric layer 15 has a first visible logo 25 and the second fabric layer having a second visible logo 125 and the first visible logo 25 is not visible when the second fabric layer 115 is exposed away from the body of the individual and the second visible logo 125 is not visible when the first fabric layer 15 is exposed away from the body of the individual. The collar 20 has a first side and a second side 120 and is reversable in color or it can be same color. The shirt vents 30 are bonded so that they provide comfort at the waist line and do not allow the color of the second side to be shown. By making the shirt from two separate fabric pieces first fabric layer 15 and second fabric layer 115 the instant invention provides the ability to provide different colors and logos in the correct orientation and it allows the individual to select which side of the shirt they want to be exposed. This allows the individual to mix and match the colors. While the instant invention is shown for a shirt the instant invention is applicable for shirts, pants, coats, hats, mask, shawls and any other piece of clothing.

The first fabric layer 15 is bonded to a second fabric layer 115 and the bonding method allows both the first fabric layer 15 and second fabric layer 115 to move together and act as one fabric. The first fabric layer 15 and second fabric layer 115 when bonded together move with each other and do not cause bunching or wrinkles. The bonding method can be achieved by a number of methods such as sewing or gluing the two fabric layers 15 and 115 together.

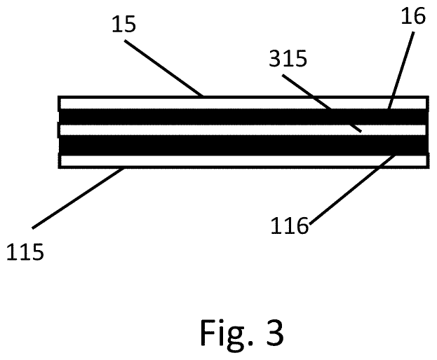

A third method as shown in FIG. 3 is to incorporate a third layer 315 which is placed between the first fabric layer 15 and the second fabric layer 115. The third layer 315 is formed from a thin or sheer fabric which is both strong and flexible material such as linen or gauze. The third layer 115 forms a bonding layer and when the first fabric layer 15 is bonded to the second fabric layer 115 using the third layer or bonding layer 315 thereby forming a sandwich comprised of said first fabric layer 15, second fabric layer 115 and the third layer or bonding layer 315. Alternatively, the sheer fabric can be made using thin thread or low density of knit. This process results in a semi-transparent and flimsy cloth or fabric. The third layer or bonding layer 315 has bonding material 16 applied to the side proximal to first fabric layer 15 and third layer 315 has bonding material 116 applied to the side proximal to second fabric layer 115. The bonding material 16 and bonding material 116 can be selected from the following materials pressure activated adhesives, heat activated adhesive, cool activated adhesive, spray adhesive, epoxy adhesives, polyurethane adhesives, polyimide adhesives, hot melt adhesives, reactive hot melt adhesives, thermosetting adhesives and contact adhesives. When contact adhesive is used then the user must apply adhesive to both surfaces to be bonded.

The seams as disclosed for the pieces of fabric that make up the first fabric layer 15 are flat and not exposed and the seams for the pieces of fabric that make up the second fabric layer 115 are flat and not exposed.

The clothes are made with high quality materials, taking into account the needs of the disabled individuals and their sensory problems. For comfort, the seams are flat and not exposed. Many disabled individuals have a hypersensitivity to texture and to surface irregularities and the use of soft fabrics with low profile flat seams makes the clothing of the instant invention more conducive to disable individual's needs.

The clothing of the instant invention can also be made using bright colors to provide easy identification of the individual wearing the garment or clothing item and the cloth or fabric is preferably a soft, cool and dry such as cotton fabrics. The fabric is preferably selected for comfort and feel for the first fabric layer 15 and the second fabric layer 115 to make the garment comfortable for the individual wearing the garment. However, any suitable fabric is usable. Additionally, bright colors used, include neon colors which are recommend so that the individual is easily identifiable in a crowded venue so that another individual can easily spot the individual wearing the clothing. Typical neon colors include:
a. Green—Neon (or “UFO”) Green, Electric Lime.
b. Red—Bright Red, Electric Orange.
c. Blue—Electric Blue, Electric Cyan.
d. Pink—Neon (or “Plastic”) Pink, Neon Magenta.
e. Purple—Bright (or “Proton”) Purple.
f. Yellow—Neon Yellow, Bright Chartreuse, or Absinthe.

The logos 25 and 125 are applied with stamps or printing so that the logo does not have a reverse side and cannot be seen or can bleed though to the other fabric side. This provides the ability to stamp both sides of the clothing and that the reverse stamp does not show through the fabric such that the logos are always presented correctly and not blurred by the logo on the reverse side of the garment or clothing item. The logos 25 and 125 can also be reflective and can have additional bands on both sides for added security in poorly lit areas for ease of localization and identification of the wearer.

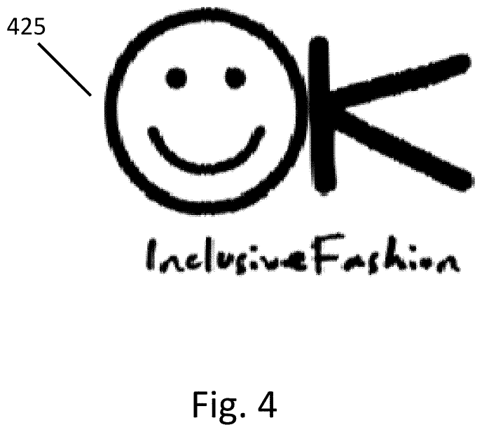

FIG. 4 shows a typical logo 25 or logo 125 which is shown as logo 425.

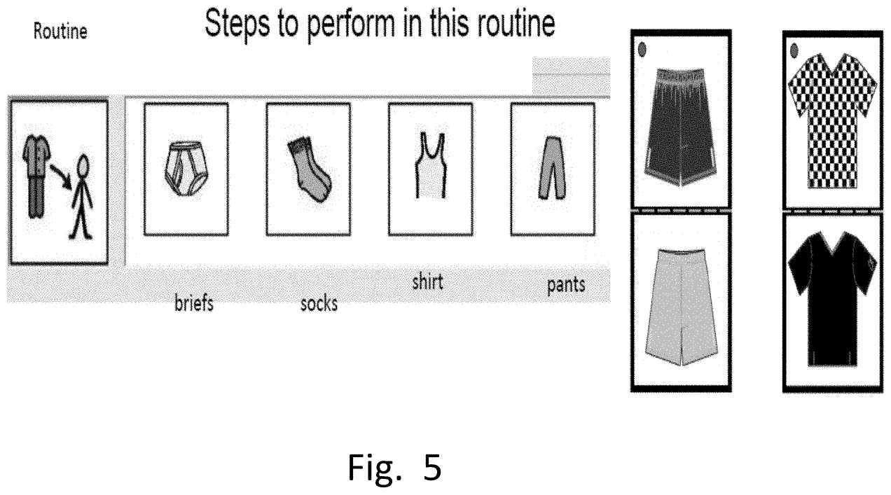

FIG. 5 shows labels which provide an educational strategy for use by individuals with disabilities to create structure and promote the ability for a person with a disability to dress themselves. The clothes of the instant invention are distributed with labels such as pictograms so that they can be used in the education of the individual. The pictogram can be located on a surface or floor to coach the individual so they put the clothes on correctly. The pictogram could be placed on the floor showing a footprint to visually identify the left shoe in blue sticker and the right shoe in red sticker. Once the product is purchased, the customer has the option of not discarding the label or labels and can use the labels to reinforce user skills. The labels can provide the user or individual with the steps to dress themselves such as step 1 put on briefs, step 2 put on socks, step 3 put on shirt and step 4 put on pants. Typical labels include routine 510, briefs 515, socks 520, shirt 525 and pants 530.

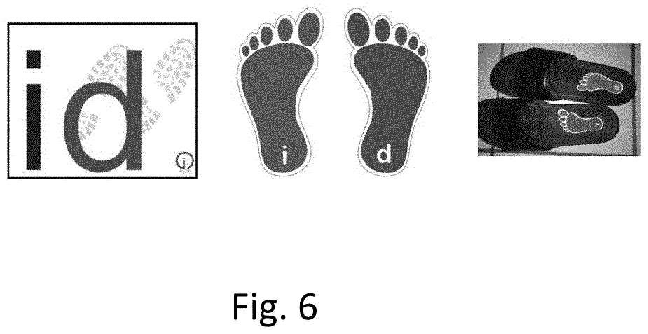

FIG. 6 shows an identification method 610 of the instant invention for shoes comprising of an accessory type sticker that adheres inside the shoe. The figure shows footprint to visually identify the left shoe with a blue sticker 615 and the right shoe with a red sticker 620. The instant invention preferably uses a 3M resistant material to create the sticker laminate but any material which is resistant to the moisture and pressure from an individual's feet can be used. The identification system can be used in open or closed footwear. The sticker is accompanied by a pictogram for use by the individual and to reinforce which shoe goes on which foot. Alternatively, the sticker can also be used with gloves which also have right and left hand symmetry.

The instant invention can also be used to create reversible pants, shorts and shirts, with either a stamped or printed logo. The logo can be applied with any type of printing process that does not result in transfer of the ink through the fabric.

Since clothing is made of two fabric layers it can be easily reversible. For example, the shirt has an outer fabric layer bonded to the inner fabric layer with flat seams.

The instant invention can also be used to create reversible mask and labeled shoes. The instant invention can also be used when making of masks where there is an inner layer and outer layer and the layers are reversible. This can help a disabled person put their mask on with the correct layer facing outward.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A clothing item wherein said clothing item comprises:
a first fabric layer and a second fabric layer;
said first fabric layer is sewed together from a plurality of pieces of fabric such that the seams are flat using a flat seam forming method;
said second fabric layer is sewed together from a plurality of pieces of fabric such that the seams are flat using a flat seam forming method;
said first fabric layer collar is made from the first fabric layer and it forms said second fabric layer collar;
said first fabric layer is bonded using a bonding method to said second fabric layer;
a logo is printed on said first fabric layer;
a logo is printed on said second fabric layer;
said first fabric layer and a second fabric layer when bonded together using said bonding method form said clothing item which is reversable; and
said clothing item having a sticker identifying the piece of clothing which corresponds to a pictogram that provides information for training and education of people with disabilities.

2. The clothing item of claim 1 wherein the bonding method is selected from the group consisting of sewing and gluing with adhesive.

3. The clothing item of claim 2 wherein the adhesive is selected from the group consisting of materials pressure activated adhesives, heat activated adhesive, cool activated adhesive, spray adhesive, epoxy adhesives, polyurethane adhesives, polyimide adhesives, hot melt adhesives, reactive hot melt adhesives, thermosetting adhesives and contact adhesives.

4. The clothing item of claim 1 wherein the flat seam forming method is selected from the group consisting of ultrasonic bonding, adhesive gluing, flat felled seam and a double lapped seam.

5. A clothing item wherein said clothing item comprises:
a first fabric layer, a bonding layer and a second fabric layer;
said first fabric layer is sewed together from a plurality of pieces of fabric such that the seams are flat using a flat seam forming method;
said second fabric layer is sewed together from a plurality of pieces of fabric such that the seams are flat using a flat seam forming method;
said first fabric layer collar is made from the first fabric layer and it forms said second fabric layer collar;
said first fabric layer is bonded to said second fabric layer using said bonding layer thereby forming a sandwich comprised of said first fabric layer, said second fabric layer and said bonding layer;
a logo is printed on said first fabric layer;
a logo is printed on said second fabric layer;
said first fabric layer and a second fabric layer when bonded together form a reversable clothing item; and
said clothing item having a sticker identifying the piece of clothing which corresponds to a pictogram that provides information for training and education of people with disabilities.

6. The clothing item of claim 5 wherein the bonding layer comprises of a sheer fabric with bonding adhesive on the first fabric layer side of the sheer fabric and bonding adhesive on the second fabric layer side of the sheer fabric.

7. The clothing item of claim 6 wherein the bonding adhesive is selected from the group consisting of pressure activated adhesives, heat activated adhesive, cool activated adhesive, spray adhesive, epoxy adhesives, polyurethane adhesives, polyimide adhesives, hot melt adhesives, reactive hot melt adhesives, thermosetting adhesives and contact adhesives.

8. The clothing item of claim 5 wherein the flat seam forming method is selected from the group consisting of ultrasonic bonding, adhesive gluing, flat felled seam and a double lapped seam.

9. A clothing item wherein said clothing item comprises:
a first fabric layer and a second fabric layer;
said first fabric layer made of a plurality of pieces of fabric;
said second fabric layer made of a plurality of pieces of fabric;
said first fabric layer plurality of pieces of fabric is sewed together such that the seams are flat using a flat seam forming method;
said second fabric layer plurality of pieces of fabric is sewed together such that the seams are flat using a flat seam forming method;
said first fabric layer collar is made from the first fabric layer;
said second fabric layer collar is made from the second fabric layer;
said first fabric layer is bonded using a bonding method to said second fabric layer;
a logo is printed on said first fabric layer;
a logo is printed on said second fabric layer;
wherein said first fabric layer and a second fabric layer when bonded together form a reversable clothing item; and
said clothing item having a sticker identifying the piece of clothing which corresponds to a pictogram that provides information for training and education of people with disabilities.

10. The clothing item of claim 9 wherein the bonding method is selected from the group consisting of sewing and gluing with adhesive.

11. The clothing item of claim 10 wherein the adhesive is selected from the group consisting of materials pressure activated adhesives, heat activated adhesive, cool activated adhesive, spray adhesive, epoxy adhesives, polyurethane adhesives, polyimide adhesives, hot melt adhesives, reactive hot melt adhesives, thermosetting adhesives and contact adhesives.

12. The clothing item of claim 9 wherein the flat seam forming method is selected from the group consisting of ultrasonic bonding, adhesive gluing, flat felled seam and a double lapped seam.
